(19) United States
(12) Patent Application Publication
(10) Pub. No.: US 2009/0217582 A1
(43) Pub. Date: Sep. 3, 2009

(54) Processes for Making Adsorbents and Processes for Removing Contaminants from Fluids Using Them

(75) Inventors: James C. May, Carbondale, IL (US); Earl T. Robinson, Lakeland, FL (US)

Correspondence Address: MCDONNELL BOEHNEN HULBERT & BERGHOFF LLP, 300 S. WACKER DRIVE, SUITE 3100, CHICAGO, IL, 60606, US

(73) Assignee: GreatPoint Energy, Inc., Chicago, IL (US)

(21) Appl. No.: 12/395,293

(22) Filed: Feb. 27, 2009

Related U.S. Application Data
(60) Provisional application No. 61/032,679, filed on Feb. 29, 2008.

(51) Int. Cl. C01B 3/32; C10G 25/00; B01J 20/20

(52) U.S. Cl. 48/127.3; 208/299; 502/416

(57) ABSTRACT

The present invention provides carbon-containing adsorbent materials as well as processes for making them and processes for using them to remove contaminants from fluids. One embodiment of the invention is a process for removing a contaminant from a fluid, the process comprising: (a) providing an activated carbon material made using a process comprising (1) providing a particulate petroleum coke feedstock; (2) reacting the petroleum coke feedstock in a gasifying reactor in the presence of steam and an alkali metal gasification catalyst under suitable temperature and pressure to form a plurality of gaseous products comprising methane and at least one or more of hydrogen, carbon monoxide, carbon dioxide, hydrogen sulfide, ammonia and other higher hydrocarbons, and a petroleum coke char residue comprising an alkali metal gasification catalyst residue; and (3) substantially extracting the alkali metal gasification catalyst residue from the petroleum coke char residue to form the carbon-containing adsorbent material; and (b) contacting the fluid with the carbon-containing adsorbent material to form a contaminated carbon-containing adsorbent material and a purified fluid.

### CROSS-REFERENCE TO RELATED APPLICATIONS

This application claims priority under 35 U.S.C. §119 from U.S. Provisional Application Ser. No. 61/032,679 (filed Feb. 29, 2008), the disclosure of which is incorporated by reference herein for all purposes as if fully set forth.

### FIELD OF THE INVENTION

The present invention relates to carbon-containing adsorbent materials and processes for making them. Moreover, the invention also relates to processes for removing contaminants from fluids using the adsorbent materials of the invention.

### BACKGROUND OF THE INVENTION

In view of numerous factors such as higher energy prices and environmental concerns, the production of value-added gaseous products from lower-fuel-value carbonaceous feedstocks, such as biomass, coal and petroleum coke, is receiving renewed attention. The catalytic gasification of such materials to produce methane and other value-added gases is disclosed, for example, in U.S. Pat. No. 3,828,474, U.S. Pat. No. 3,998,607, U.S. Pat. No. 4,057,512, U.S. Pat. No. 4,092,125, U.S. Pat. No. 4,094,650, U.S. Pat. No. 4,204,843, U.S. Pat. No. 4,468,231, U.S. Pat. No. 4,500,323, U.S. Pat. No. 4,541,841, U.S. Pat. No. 4,551,155, U.S. Pat. No. 4,558,027, U.S. Pat. No. 4,606,105, U.S. Pat. No. 4,617,027, U.S. Pat. No. 4,609,456, U.S. Pat. No. 5,017,282, U.S. Pat. No. 5,055,181, U.S. Pat. No. 6,187,465, U.S. Pat. No. 6,790,430, U.S. Pat. No. 6,894,183, U.S. Pat. No. 6,955,695, US2003/0167961A1, US2006/0265953A1, US2007/000177A1, US2007/083072A1, US2007/0277437A1 and GB1599932.

Petroleum coke is a generally solid carbonaceous residue derived from delayed coking or fluid coking a carbon source such as a crude oil residue. Petroleum coke in general has a poorer gasification reactivity, particularly at moderate temperatures, than does bituminous coal due, for example, to its highly crystalline carbon and elevated levels of organic sulfur derived from heavy-gravity oil. Use of catalysts is necessary for improving the lower reactivity of petroleum cokes.

Treatment of petroleum coke alone can provide very high theoretical carbon conversion (e.g., 98%), but has its own challenges regarding maintaining bed composition, fluidization of the bed in the gasification reactor, control of possible liquid phases and agglomeration of the bed in the gasification reactor, and char withdrawal. Moreover, catalytic gasification of petroleum coke can result in significant quantities of carbonaceous petroleum coke char residue, which can represent a loss of potentially useful carbon and can also present issues with respect to waste disposal. Accordingly, processes are needed which can efficiently utilize petroleum coke char residue.

### SUMMARY OF THE INVENTION

In one aspect, the present invention provides a process for removing a contaminant from a fluid, the process comprising the steps of: (a) providing a carbon-containing adsorbent material made using a process comprising (1) providing a particulate petroleum coke feedstock; (2) reacting the petroleum coke feedstock in a gasifying reactor in the presence of steam and an alkali metal gasification catalyst under suitable temperature and pressure to form a plurality of gaseous products comprising methane and at least one or more of hydrogen, carbon monoxide, carbon dioxide, hydrogen sulfide, ammonia and other higher hydrocarbons, and a petroleum coke char residue comprising an alkali metal gasification catalyst residue; and (3) substantially extracting the alkali metal gasification catalyst residue from the petroleum coke char residue to form the carbon-containing adsorbent material; and (b) contacting the fluid with the carbon-containing adsorbent material to form a contaminated carbon-containing adsorbent material and a purified fluid.

In a second aspect, the present invention provides a process for removing a contaminant from a fluid, the process comprising the steps of: (a) providing a particulate petroleum coke feedstock; (b) reacting the petroleum coke feedstock in a gasifying reactor in the presence of steam and an alkali metal gasification catalyst under suitable temperature and pressure to form a plurality of gaseous products comprising methane and at least one or more of hydrogen, carbon monoxide, carbon dioxide, hydrogen sulfide, ammonia and other higher hydrocarbons, and a petroleum coke char residue comprising an alkali metal gasification catalyst residue; (c) substantially extracting the alkali metal gasification catalyst residue from the petroleum coke char residue to form a carbon-containing adsorbent material; and (d) contacting the fluid with the carbon-containing adsorbent material to form a contaminated carbon-containing adsorbent material and a purified fluid.

In a third aspect, the present invention provides a process of making a carbon-containing adsorbent material, the process comprising the steps of: (a) providing a particulate petroleum coke feedstock; (b) reacting the petroleum coke feedstock in a gasifying reactor in the presence of steam and an alkali metal gasification catalyst under suitable temperature and pressure to form a plurality of gaseous products comprising methane and at least one or more of hydrogen, carbon monoxide, carbon dioxide, hydrogen sulfide, ammonia and other higher hydrocarbons, and a petroleum coke char residue comprising an alkali metal gasification catalyst residue; (c) substantially extracting the alkali metal gasification catalyst residue from the petroleum coke char residue to form the carbon-containing adsorbent material; and (d) contacting the carbon-containing adsorbent material with an oxidizing atmosphere at a temperature in the range of from about 200° C. to about 1300° C.

### DETAILED DESCRIPTION

The present invention relates to processes for making carbon-containing adsorbent materials and to processes for removing contaminants from fluids. Generally, the process for preparing the carbon-containing adsorbent materials include catalytically gasifying a petroleum coke feedstock, and substantially extracting the alkali metal gasification catalyst residue from the resulting petroleum coke char residue to form the activated carbon material. Such processes can provide for an economical and commercially practical process for catalytic gasification of petroleum coke to yield methane and/or other value-added gases, as well as a carbon-containing adsorbent material as products. The conversion of the petroleum coke char residue to a carbon-containing adsorbent material can result in less overall waste and lower disposal costs. The carbon-containing adsorbent material can be used, for example, to remove a contaminant from a fluid in a wide variety of industrial and environmental applications.

The present invention can be practiced, for example, using any of the developments to catalytic gasification technology disclosed in commonly owned US2007/0000177A1, US2007/0083072A1 and US2007/0277437A1; and U.S. patent application Ser. No. 12/178,380 (filed 23 Jul. 2008), Ser. No. 12/234,012 (filed 19 Sep. 2008) and Ser. No. 12/234,018 (filed 19 Sep. 2008). All of the above are incorporated by reference herein for all purposes as if fully set forth.

Moreover, the present invention can be practiced in conjunction with the subject matter of the following U.S. Patent Applications, each of which was filed on Dec. 28, 2008: Ser. No. 12/342,554, entitled “CATALYTIC GASIFICATION PROCESS WITH RECOVERY OF ALKALI METAL FROM CHAR”; Ser. No. 12/342,565, entitled “PETROLEUM COKE COMPOSITIONS FOR CATALYTIC GASIFICATION”; Ser. No. 12/342,578, entitled “COAL COMPOSITIONS FOR CATALYTIC GASIFICATION”; Ser. No. 12/342,596, entitled “PROCESSES FOR MAKING SYNTHESIS GAS AND SYNGAS-DERIVED PRODUCTS”; Ser. No. 12/342,608, entitled “PETROLEUM COKE COMPOSITIONS FOR CATALYTIC GASIFICATION”; Ser. No. 12/342,628, entitled “PROCESSES FOR MAKING SYNGAS-DERIVED PRODUCTS”; Ser. No. 12/342,663, entitled “CARBONACEOUS FUELS AND PROCESSES FOR MAKING AND USING THEM”; Ser. No. 12/342,715, entitled “CATALYTIC GASIFICATION PROCESS WITH RECOVERY OF ALKALI METAL FROM CHAR”; Ser. No. 12/342,736, entitled “CATALYTIC GASIFICATION PROCESS WITH RECOVERY OF ALKALI METAL FROM CHAR”; Ser. No. 12/343,143, entitled “CATALYTIC GASIFICATION PROCESS WITH RECOVERY OF ALKALI METAL FROM CHAR”; Ser. No. 12/343,149, entitled “STEAM GENERATING SLURRY GASIFIER FOR THE CATALYTIC GASIFICATION OF A CARBONACEOUS FEEDSTOCK”; and Ser. No. 12/343,159, entitled “CONTINUOUS PROCESSES FOR CONVERTING CARBONACEOUS FEEDSTOCK INTO GASEOUS PRODUCTS”. All of the above are incorporated by reference herein for all purposes as if fully set forth.

Further, the present invention can be practiced in conjunction with the subject matter of the following U.S. Patent Applications, each of which was filed concurrently herewith: Ser. No. ______, entitled “STEAM GENERATION PROCESSES UTILIZING BIOMASS FEEDSTOCKS” (attorney docket no. FN-0020 US NP1); Ser. No. ______, entitled “REDUCED CARBON FOOTPRINT STEAM GENERATION PROCESSES” (attorney docket no. FN-0021 US NP1); Ser. No. ______, entitled “PROCESS AND APPARATUS FOR THE SEPARATION OF METHANE FROM A GAS STREAM” (attorney docket no. FN-0022 US NP1); Ser. No. ______, entitled “SELECTIVE REMOVAL AND RECOVERY OF ACID GASES FROM GASIFICATION PRODUCTS” (attorney docket no. FN-0023 US NP1); Ser. No. ______, entitled “COAL COMPOSITIONS FOR CATALYTIC GASIFICATION” (attorney docket no. FN-0024 US NP1); Ser. No. ______, entitled “COAL COMPOSITIONS FOR CATALYTIC GASIFICATION” (attorney docket no. FN-0025 US NP1); Ser. No. ______, entitled “CO-FEED OF BIOMASS AS SOURCE OF MAKEUP CATALYSTS FOR CATALYTIC COAL GASIFICATION” (attorney docket no. FN-0026 US NP1); Ser. No. ______, entitled “COMPACTOR-FEEDER” (attorney docket no. FN-0027 US NP1); Serial No. , entitled “CARBONACEOUS FINES RECYCLE” (attorney docket no. FN-0028 US NP1); Ser. No. ______, entitled “BIOMASS CHAR COMPOSITIONS FOR CATALYTIC GASIFICATION” (attorney docket no. FN-0029 US NP1); Ser. No. ______, entitled “CATALYTIC GASIFICATION PARTICULATE COMPOSITIONS” (attorney docket no. FN-0030 US NP1); and Ser. No. ______, entitled “BIOMASS COMPOSITIONS FOR CATALYTIC GASIFICATION” (attorney docket no. FN-0031 US NP1). All of the above are incorporated herein by reference for all purposes as if fully set forth.

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present invention be limited to the specific values recited when defining a range.

When the term “about” is used in describing a value or an end-point of a range, the invention should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting.

### Petroleum Coke

The term “petroleum coke” as used herein includes both (i) the solid thermal decomposition product of high-boiling hydrocarbon fractions obtained in petroleum processing (heavy residues—“resid petcoke”) and (ii) the solid thermal decomposition product of processing tar sands (bituminous sands or oil sands—“tar sands petcoke”). Such products include, for example, green, calcined, needle and fluidized bed petroleum coke.

Resid petcoke can be derived from a crude oil, for example, by coking processes used for upgrading heavy-gravity residual crude oil, which petroleum coke contains ash as a minor component, typically about 1.0 wt % or less, and more typically about 0.5 wt % of less, based on the weight of the coke. Typically, the ash in such lower-ash cokes predominantly comprises metals such as nickel and vanadium.

Tar sands petcoke can be derived from an oil sand, for example, by coking processes used for upgrading oil sand. Tar sands petcoke contains ash as a minor component, typically in the range of about 2 wt % to about 12 wt %, and more typically in the range of about 4 wt % to about 12 wt %, based on the overall weight of the tar sands petcoke. Typically, the ash in such higher-ash cokes predominantly comprises materials such as compounds of silicon and/or aluminum.

The petroleum coke (either resid petcoke or tar sands petcoke) can comprise at least about 70 wt % carbon, at least about 80 wt % carbon, or at least about 90 wt % carbon, based on the total weight of the petroleum coke. Typically, the petroleum coke comprises less than about 20 wt % percent inorganic compounds, based on the weight of the petroleum coke.

Petroleum coke in general can have an inherently low moisture content typically in the range of from about 0.2 to about 2 wt %. (based on total petroleum coke weight); it also typically has a very low water soaking capacity to allow for conventional catalyst impregnation methods.

### Catalytic Gasification Methods

The gasification processes referred to in the context of the present invention include reacting a particulate petroleum coke feedstock in a gasifying reactor in the presence of steam and a gasification catalyst under suitable temperature and pressure to form a plurality of gaseous products comprising methane and at least one or more of hydrogen, carbon monoxide, carbon dioxide, hydrogen sulfide, ammonia and other higher hydrocarbons, and a solid char residue comprising an alkali metal gasification catalyst residue. Examples of such gasification processes are, disclosed, for example, in the various previously incorporated disclosures referenced above.

One advantageous catalytic process for gasifying petroleum cokes to methane and other value-added gaseous products is disclosed in previously incorporated US2007/0083072A1.

The gasification reactors for such processes are typically operated at moderately high pressures and temperatures, requiring introduction of the particulate petroleum coke feedstock to the reaction zone of the gasification reactor while maintaining the required temperature, pressure, and flow rate of the particulate petroleum coke feedstock. Those skilled in the art are familiar with feed systems for providing feedstocks to high pressure and/or temperature environments, including, star feeders, screw feeders, rotary pistons, and lock-hoppers. It should be understood that the feed system can include two or more pressure-balanced elements, such as lock hoppers, which would be used alternately.

In some instances, the particulate petroleum coke feedstock can be prepared at pressure conditions above the operating pressure of gasification reactor. Hence, the particulate petroleum coke feedstock can be directly passed into the gasification reactor without further pressurization.

Typically, the petroleum coke feedstock is supplied to the gasifying reactor as particulates having an average particle size of from about 250 microns, from about 45 microns, or from about 25 microns, up to about 500, or up to about 2500 microns. One skilled in the art can readily determine the appropriate particle size for the particulates. For example, when a fluid bed gasification reactor is used, the particulate petroleum coke feedstock can have an average particle size which enables incipient fluidization of the particulate petroleum coke feedstock at the gas velocity used in the fluid bed gasification reactor. Processes for preparing particulates are described in more detail below.

Any of several catalytic gasifiers can be utilized. Suitable gasification reactors include counter-current fixed bed, co-current fixed bed, fluidized bed, entrained flow, and moving bed reactors. The gasification reactor typically will be operated at temperatures of at least about 450° C., or of at least about 600° C. or above, to about 900° C, or to about 750° C., or to about 700° C.; and at pressures of at least about 50 psig, or at least about 200 psig, or at least about 400 psig, to about 1000 psig, or to about 700 psig, or to about 600 psig.

The gas utilized in the gasification reactor for pressurization and reactions of the particulate petroleum coke feedstock typically comprises steam, and optionally oxygen, air, CO and/or H₂, and is supplied to the reactor according to methods known to those skilled in the art. Typically, the carbon monoxide and hydrogen produced in the gasification is recovered and recycled. In some embodiments, however, the gasification environment remains substantially free of air, particularly oxygen. In one embodiment of the invention, the reaction of the petroleum coke feedstock is carried out in an atmosphere having less than 1% oxygen by volume.

Any of the steam boilers known to those skilled in the art can supply steam to the gasification reactor. Such boilers can be fueled, for example, through the use of any carbonaceous material such as powdered coal, biomass etc., and including but not limited to rejected carbonaceous materials from the particulate petroleum coke feedstock preparation operation (e.g., fines, supra). Steam can also be supplied from a second gasification reactor coupled to a combustion turbine where the exhaust from the reactor is thermally exchanged to a water source to produce steam. Steam may also be generated from heat recovered from the hot raw gasifier product gas. Alternatively, the steam may be provided to the gasification reactor as described in previously incorporated U.S. patent applications Ser. No. ______, entitled “STEAM GENERATION PROCESSES UTILIZING BIOMASS FEEDSTOCKS” (attorney docket no. FN-0020 US NP1), and Ser. No. ______, entitled “REDUCED CARBON FOOTPRINT STEAM GENERATION PROCESSES” (attorney docket no. FN-0021 US NP1).

Recycled steam from other process operations can also be used for supplying steam to the gasification reactor. For example, when slurried particulate petroleum coke feedstock is dried with a fluid bed slurry drier (as discussed below), the steam generated through vaporization can be fed to the gasification reactor.

The small amount of required heat input for the catalytic gasification reaction can be provided by superheating a gas mixture of steam and recycle gas feeding the gasification reactor by any method known to one skilled in the art. In one method, compressed recycle gas of CO and H₂ can be mixed with steam and the resulting steam/recycle gas mixture can be further superheated by heat exchange with the gasification reactor effluent followed by superheating in a recycle gas furnace.

A methane reformer can be included in the process to supplement the recycle CO and H₂ fed to the reactor to ensure that enough recycle gas is supplied to the reactor so that the net heat of reaction is as close to neutral as possible (only slightly exothermic or endothermic), in other words, that the reaction is run under thermally neutral conditions. In such instances, methane can be supplied for the reformer from the methane product, as described below.

Reaction of the particulate petroleum coke feedstock under the described conditions typically provides a crude product gas comprising a plurality of gaseous products comprising methane and at least one or more of hydrogen, carbon monoxide, carbon dioxide, hydrogen sulfide, ammonia and other higher hydrocarbons, and a solid char residue. The term “char” as used herein includes mineral ash, unconverted carbon, alkali metal gasification catalyst residue (water-soluble alkali metal compounds and water-insoluble alkali metal compounds), and other solid components remaining from the petcoke.

The char residue produced in the gasification reactor during the present processes is typically removed from the gasification reactor for sampling, purging, and/or catalyst recovery. In the processes of the present invention, the petroleum coke char residue is converted to a carbon-containing adsorbent material, as described in more detail below. Methods for removing char residue are well known to those skilled in the art. One such method taught by EP-A-0102828, for example, can be employed. The char residue can be periodically withdrawn from the gasification reactor through a lock hopper system, although other methods are known to those skilled in the art.

The char residue can be quenched with recycle gas and water and directed to a catalyst recycling operation for extraction and reuse of the alkali metal catalyst. Particularly useful recovery and recycling processes are described in U.S. Pat. No. 4,459,138, as well as previously incorporated U.S. Pat. No. 4,057,512 and US2007/0277437A1, and previously incorporated U.S. patent application Ser. Nos. 12/342,554, 12/342,715, 12/342,736 and 12/343,143. Reference can be had to those documents for further process details.

Crude product gas effluent leaving the gasification reactor can pass through a portion of the gasification reactor which serves as a disengagement zone where particles too heavy to be entrained by the gas leaving the gasification reactor are returned to the fluidized bed. The disengagement zone can include one or more internal cyclone separators or similar devices for removing particulates from the gas. The crude gas effluent stream passing through the disengagement zone and leaving the gasification reactor generally contains CH₄, CO₂, H₂, CO, H₂S, NH₃, unreacted steam, gas-entrained carbonaceous fines, and other trace contaminants such as COS.

Residual gas-entrained particles are typically removed by suitable apparatuses such as external cyclone separators, optionally followed by Venturi scrubbers. The recovered particles can be processed to recover alkali metal catalyst. The recovered particles can also be recycled to the feedstock preparation process, as described in previously incorporated U.S. patent application Ser. No. ______, entitled “CARBONACEOUS FINES RECYCLE” (attorney docket no. FN-0028 US NP1).

The gas stream from which the fines have been removed can then be passed through a heat exchanger to cool the gas and the recovered heat can be used to preheat recycle gas and generate high pressure steam. The gas stream exiting the Venturi scrubbers can be fed to COS hydrolysis reactors for COS removal (sour process) and further cooled in a heat exchanger to recover residual heat prior to entering water scrubbers for ammonia recovery, yielding a scrubbed gas comprising at least H₂S, CO₂, CO, H₂ and CH₄. Methods for COS hydrolysis are known to those skilled in the art, for example, see U.S. Pat. No. 4,100,256.

The residual heat from the scrubbed gas can be used to generate low pressure steam. Scrubber water and sour process condensate can be processed to strip and recover H₂S, CO₂ and NH₃; such processes are well known to those skilled in the art. NH₃ can typically be recovered as an aqueous solution (e.g., 20 wt %).

A subsequent acid gas removal process can be used to remove H₂S and CO₂ from the scrubbed gas stream by a physical or chemical absorption method involving solvent treatment of the gas to give a cleaned gas stream. Such processes involve contacting the scrubbed gas with a solvent such as monoethanolamine, diethanolamine, methyldiethanolamine, diisopropylamine, diglycolamine, a solution of sodium salts of amino acids, methanol, hot potassium carbonate or the like. One method can involve the use of SELEXOL (UOP LLC, Des Plaines, Ill. USA) or RECTISOL® (Lurgi AG, Frankfurt am Main, Germany) solvent having two trains; each train consisting of an H₂S absorber and a CO₂ absorber. The spent solvent containing H₂S, CO₂ and other contaminants can be regenerated by any method known to those skilled in the art, including contacting the spent solvent with steam or other stripping gas to remove the contaminants or by passing the spent solvent through stripper columns. Recovered acid gases can be sent for sulfur recovery processing. The resulting cleaned gas stream contains mostly CH₄, H₂, and CO and, typically, small amounts of CO₂ and H₂O. Any recovered H₂S from the acid gas removal and sour water stripping can be converted to elemental sulfur by any method known to those skilled in the art, including the Claus process. Sulfur can be recovered as a molten liquid. Stripped water can be directed for recycled use in preparation of the first and/or second carbonaceous feedstock. One method for removing acid gases from the scrubbed gas stream is described in previously incorporated U.S. patent application Ser. No. ______, entitled “SELECTIVE REMOVAL AND RECOVERY OF ACID GASES FROM GASIFICATION PRODUCTS” (attorney docket no. FN-0023 US NP1).

In certain embodiments of the invention, the plurality of gaseous products are at least partially separated to form a gas stream comprising a predominant amount of one of the gaseous products. For example, the cleaned gas stream can be further processed to separate and recover CH₄ by any suitable gas separation method known to those skilled in the art including, but not limited to, cryogenic distillation and the use of molecular sieves or ceramic membranes, or via the generation of methane hydrate as disclosed in previously incorporated U.S. patent application Ser. No. ______, entitled “PROCESS AND APPARATUS FOR THE SEPARATION OF METHANE FROM A GAS STREAM” (attorney docket no. FN-0022 US NP1).

Typically, two gas streams can be produced by the gas separation process, a methane product stream and a syngas stream (H₂ and CO). The syngas stream can be compressed and recycled to the gasification reactor. If necessary, a portion of the methane product can be directed to a reformer, as discussed previously and/or a portion of the methane product can be used as plant fuel.

Further process details can be had by reference to the previously incorporated publications and applications.

### Gasification Catalyst

Gasification processes according to the present invention use a petroleum coke feedstock and further use an amount of an alkali metal gasification catalyst (e.g., including an alkali metal and/or a compound containing alkali metal), as well as optional co-catalysts, as disclosed in the previous incorporated references. Typically, the quantity of the alkali metal component in the composition is sufficient to provide a ratio of alkali metal atoms to carbon atoms in the range of from about 0.01, or from about 0.02, or from about 0.03, or from about 0.04, to about 0.06, or to about 0.07, or to about 0.08. Further, the alkali metal is typically loaded onto a carbon source to achieve an alkali metal content of from about 3 to about 10 times more than the combined ash content of the petroleum coke feedstock, on a mass basis.

Suitable alkali metals are lithium, sodium, potassium, rubidium, cesium, and mixtures thereof. Particularly useful are potassium sources. Suitable alkali metal compounds include alkali metal carbonates, bicarbonates, formates, oxalates, amides, hydroxides, acetates, polysulfides and similar compounds. For example, the catalyst can comprise one or more of Na₂CO₃, K₂CO₃, Rb₂CO₃, Li₂CO₃, Cs₂CO₃, NaOH, KOH, RbOH or CsOH, and particularly, potassium carbonate and/or potassium hydroxide.

Petroleum coke feedstocks may include a quantity of inorganic matter (e.g. including calcium, alumina and/or silica) which form inorganic oxides (“ash”) in the gasification reactor. At temperatures above about 500 to 600° C., potassium and other alkali metals can react with the alumina and silica in ash to form insoluble alkali aluminosilicates. In this form, the alkali metal is substantially water-insoluble and inactive as a catalyst. To prevent buildup of the residue in a coal gasification reactor, a solid purge of char residue, i.e., solids composed of ash, unreacted or partially-reacted petroleum coke feedstock, and various alkali metal compounds (both water soluble and water insoluble) are routinely withdrawn. Preferably, the alkali metal is recovered from the char residue for recycle; any unrecovered catalyst is generally compensated by a catalyst make-up stream. The more alumina and silica in the feedstock, the more costly it is to obtain a higher alkali metal recovery.

The ash content of the petroleum coke feedstock can be selected to be, for example, to be about 12 wt % or less, or about 10 wt % or less, or about 8 wt % or less.

In the methods of the present invention, the alkali metal from the gasification catalyst is substantially extracted (e.g., greater than about 70 molar %, or greater than about 80 molar %, or greater than about 90 molar %, or even greater than about 95 molar %, alkali metal extraction based on the akali metal content of the petroleum coke char residue) from the petroleum coke char residue. As described above, processes have been developed to recover gasification catalysts (such as alkali metals) from the solid purge in order to reduce raw material costs and to minimize environmental impact of a catalytic gasification process.

### Methods for Preparing the Petroleum Coke Feedstock for Gasification

The petroleum coke feedstock can come from a single source, or from two or more sources. For example, the petroleum coke feedstock can be formed from one or more tar sands petcoke materials, one or more resid petcoke materials, or a mixture of the two.

The petroleum coke feedstock for use in the gasification process can require initial processing.

The petroleum coke feedstock can be crushed and/or ground according to any methods known in the art, such as impact crushing and wet or dry grinding to yield particulates. Depending on the method utilized for crushing and/or grinding of the petroleum coke, the resulting particulates can need to be sized (e.g., separated according to size) to provide an appropriate particles of petroleum coke feedstock for the gasifying reactor. The sizing operation can be used to separate out the fines of the petroleum coke feedstock from the particles of petroleum coke feedstock suitable for use in the gasification process.

Any method known to those skilled in the art can be used to size the particulates. For example, sizing can be preformed by screening or passing the particulates through a screen or number of screens. Screening equipment can include grizzlies, bar screens, and wire mesh screens. Screens can be static or incorporate mechanisms to shake or vibrate the screen. Alternatively, classification can be used to separate the particulate petroleum coke feedstock. Classification equipment can include ore sorters, gas cyclones, hydrocyclones, rake classifiers, rotating trommels, or fluidized classifiers. The petroleum coke feedstock can be also sized or classified prior to grinding and/or crushing.

In one embodiment of the invention, the petroleum coke feedstock is crushed or ground, then sized to separate out fines of the petroleum coke feedstock having an average particle size less than about 45 microns from particles of petroleum coke feedstock suitable for use in the gasification process. As described in more detail below, the fines of the petroleum coke feedstock can remain unconverted (i.e., unreacted in a gasification or combustion process), then combined with char residue to provide a carbonaceous fuel of the present invention.

Any methods known to those skilled in the art can be used to associate one or more gasification catalysts with the particulate composition. Such methods include, but are not limited to, admixing with a solid catalyst source and impregnating the catalyst onto a carbonaceous material. Several impregnation methods known to those skilled in the art can be employed to incorporate the gasification catalysts. These methods include, but are not limited to, incipient wetness impregnation, evaporative impregnation, vacuum impregnation, dip impregnation, and combinations of these methods. Gasification catalysts can be impregnated into the carbonaceous material (e.g., particulate carbonaceous feedstock) by slurrying with a solution (e.g., aqueous) of the catalyst.

In some cases, a second catalyst (e.g., co-catalyst) or other additive can be provided; in such instances, the particulate can be treated in separate processing steps to provide the catalyst and co-catalyst/additive. For example, the primary gasification catalyst can be supplied (e.g., a potassium and/or sodium source), followed by a separate treatment to provide a co-catalyst source.

That portion of the petroleum coke feedstock suitable of a particle size suitable for use in the gasifying reactor can then be further processed, for example, to impregnate one or more catalysts and/or cocatalysts by methods known in the art, for example, as disclosed in U.S. Pat. No. 4,069,304; U.S. Pat. No. 4,092,125; U.S. Pat. No. 4,468,231; U.S. Pat. No. 4,551,155; U.S. Pat. No. 5,435,940; and U.S. patent application Ser. Nos. 12/234,012, 12/234,018, 12/342,565, 12/342,608 and 12/343,159.

In any process of preparing the particulate petroleum coke feedstock, the preparation environment preferably remains substantially free of air, particularly oxygen.

The catalyzed feedstock can be stored for future use or transferred to a feed operation for introduction into the gasification reactor. The catalyzed feedstock can be conveyed to storage or feed operations according to any methods known to those skilled in the art, for example, a screw conveyer or pneumatic transport.

### Formation of the Carbon-Containing Adsorbent Material

In one aspect of the present invention, a process for making a carbon-containing adsorbent material comprises providing a particulate petroleum coke feedstock (e.g., as described above); and reacting the petroleum coke feedstock in a gasifying reactor in the presence of steam and an alkali metal gasification catalyst under suitable temperature and pressure to form the plurality of gaseous products comprising methane and at least one or more of hydrogen, carbon monoxide, carbon dioxide, hydrogen sulfide, ammonia and other higher hydrocarbons, and a petroleum coke char residue (e.g., as described above). The process according to this aspect of the invention further comprises substantially extracting the alkali metal gasification catalyst residue from the petroleum coke char residue (e.g., as described above) to form the carbon-containing adsorbent material.

In certain embodiments of the invention, the process for making a carbon-containing adsorbent material further comprises contacting the carbon-containing adsorbent material with an oxidizing atmosphere at a temperature in the range of from about 200° C. to about 1300° C. The oxidizing material can be, for example, air or oxygen. In other embodiments of the invention, the oxidizing material can be carbon dioxide or steam. The contacting of the carbon-containing adsorbent material with the oxidizing atmosphere can be performed after the petroleum coke char residue is removed from the gasification reactor. For example, the contacting of the carbon-containing adsorbent material with the oxidizing atmosphere can be performed after the extraction of the gasification catalyst.

In certain embodiments of the invention, the process for making the carbon-containing adsorbent material further comprises grinding the petroleum coke char residue to reduce its particle size. For example, the petroleum coke char residue can be ground to a powder (e.g., particle sizes less than 1 mm, average diameter 0.15-0.25 mm). In other embodiments of the invention, the petroleum coke char residue is ground into granules (e.g., 8×20, 20×40, 8×30 for liquid phase applications, or 4×6, 4×7, 4×10 for vapor phase applications). The petroleum coke char residue can be ground at any time after removal from the gasification reactor. For example, in one embodiment of the invention, the petroleum coke char residue is ground before it is contacted with an oxidizing atmosphere.

In certain embodiments of the invention, the petroleum coke char residue is impregnated with an inorganic impregnant, such as a halogen, sulfur or a compound of silver, iron, manganese, zinc, lithium or calcium. For example, the petroleum coke char residue can be halogenated as described in previously incorporated US2007/0180990A1.

Another aspect of the invention is a carbon-containing adsorbent material made by any one of the methods described above.

Removing Contaminants from Fluids

The above-described processes and carbon-containing adsorbent materials can be used to remove contaminants from fluids. In one embodiment of the invention, a process for removing a contaminant from a fluid comprises providing a carbon-containing adsorbent material made using a process as described above; and contacting the fluid with the carbon-containing adsorbent material to form a contaminated carbon-containing adsorbent material and a purified fluid. For example, in one embodiment of the invention, a process for removing a contaminant from a fluid comprises: providing a particulate petroleum coke feedstock; reacting the petroleum coke feedstock in a gasifying reactor in the presence of steam and a gasification catalyst under suitable temperature and pressure to form a plurality of gaseous products comprising methane and at least one or more of hydrogen, carbon monoxide, and other higher hydrocarbons, and a petroleum coke char residue; and substantially extracting the gasification catalyst from the petroleum coke char residue to form a carbon-containing adsorbent material; and contacting the fluid with the carbon-containing adsorbent carbon material to form a contaminated activated carbon material and a purified fluid.

The carbon-containing adsorbent materials can be used to remove contaminants from a wide variety of fluids in a wide variety of applications, as would be recognized by the person of skill in the art. For example, the carbon-containing adsorbent materials and processes of the present invention can be used in gas purification, metal extraction, water purification, sewage and wastewater treatment, purification of electroplating solutions, air purification, spill cleanup, groundwater remediation, capture of VOCs from painting, drycleaning and other processes. In one embodiment of the invention, the fluid is an exhaust gas from a combustion process; the processes of the present invention can be used to remove, for example, mercury from flue gases of coal-fired power plants.

The contacting of the fluid with the carbon-containing adsorbent material can be performed in many ways familiar to the skilled artisan. The fluid can, for example, be passed through, or alternatively passed over a bed of the carbon-containing adsorbent material. In other embodiments of the invention, the carbon-containing adsorbent material is injected as a powder into a fluid stream, such as exhaust gas from a combustion process. The person of skill in the art will determine contact methods and times suitable for removing the desired contaminants from the fluid.

The contacting of the fluid with the carbon-containing adsorbent material forms a contaminated carbon-containing adsorbent material. In certain embodiments of the invention, this contaminated carbon-containing adsorbent material can be reactivated by contacting it with an oxidizing atmosphere at a temperature in the range of from about 200° C. to about 1300° C., as described above. The resulting recycled carbon-containing adsorbent material can be contacted with a fluid in order to remove a contaminant, as described above.

The contaminated carbon-containing adsorbent material can also be used as a feedstock in a gasification reaction, as described above. For example, the contaminated carbon-containing adsorbent material can be reacted in a gasifying reactor in the presence of steam and an alkali metal gasification catalyst under suitable temperature and pressure to form the plurality of gaseous products comprising methane and at least one or more of hydrogen, carbon monoxide, carbon dioxide, hydrogen sulfide, ammonia and other higher hydrocarbons, and a recycled petroleum coke char residue comprising alkali metal gasification catalyst residue. The gasification catalyst residue can be substantially extracted from the recycled petroleum coke char residue as described above to form a recycled carbon-containing adsorbent material, which can be contacted with a fluid in order to remove a contaminant, as described above.

We claim:

1. A process for removing a contaminant from a fluid, the process comprising the steps of:
providing a carbon-containing adsorbent material made using a process comprising
providing a particulate petroleum coke feedstock;
reacting the petroleum coke feedstock in a gasifying reactor in the presence of steam and an alkali metal gasification catalyst under suitable temperature and pressure to form the plurality of gaseous products comprising methane and at least one or more of hydrogen, carbon monoxide, carbon dioxide, hydrogen sulfide, ammonia and other higher hydrocarbons, and a petroleum coke char residue comprising an alkali metal gasification catalyst residue; and
substantially extracting the alkali metal gasification catalyst residue from the petroleum coke char residue to form the carbon-containing adsorbent material; and
contacting the fluid with the carbon-containing adsorbent material to form a contaminated carbon-containing adsorbent material and a purified fluid.

2. The process of claim 1, wherein the process for making the carbon-containing adsorbent material further comprises at least partially separating the plurality of gaseous products to form a gas stream comprising a predominant amount of one of the gaseous products.

3. The process of claim 1, wherein the process for making the carbon-containing adsorbent material further comprises grinding the petroleum coke char residue to reduce its particle size.

4. The process of claim 1, wherein the process for making the carbon-containing adsorbent material further comprises contacting the carbon-containing adsorbent material with an oxidizing atmosphere at a temperature in the range of from about 200° C. to about 1300° C.

5. The process of claim 1, wherein in the process for making the carbon-containing adsorbent material, the reaction of the petroleum coke feedstock is carried out in an atmosphere having less than about 1% O₂ by volume.

6. The process of claim 1, further comprising contacting the contaminated carbon-containing adsorbent material with an oxidizing atmosphere at a temperature in the range of from about 200° C. to about 1300° C.

7. The process of claim 1, further comprising reacting the contaminated carbon-containing adsorbent material in a gasifying reactor in the presence of steam and an alkali metal gasification catalyst under suitable temperature and pressure to form the plurality of gaseous products comprising methane and at least one or more of hydrogen, carbon monoxide, carbon dioxide, hydrogen sulfide, ammonia and other higher hydrocarbons, and a recycled petroleum coke char residue comprising an alkali metal gasification catalyst residue.

8. The process of claim 7, further comprising extracting the alkali metal gasification catalyst residue from the recycled petroleum coke char residue to form a recycled carbon-containing adsorbent material.

9. A process for removing a contaminant from a fluid, the process comprising the steps of:
providing a particulate petroleum coke feedstock;
reacting the petroleum coke feedstock in a gasifying reactor in the presence of steam and an alkali metal gasification catalyst under suitable temperature and pressure to form a plurality of gaseous products comprising methane and at least one or more of hydrogen, carbon monoxide, carbon dioxide, hydrogen sulfide, ammonia and other higher hydrocarbons, and a petroleum coke char residue comprising an alkali metal gasification catalyst residue; and
substantially extracting the alkali metal gasification catalyst residue from the petroleum coke char residue to form a carbon-containing adsorbent material; and
contacting the fluid with the carbon-containing adsorbent material to form a contaminated carbon-containing adsorbent material and a purified fluid.

10. A process of making a carbon-containing adsorbent material, the process comprising the steps of:
providing a particulate petroleum coke feedstock;
reacting the petroleum coke feedstock in a gasifying reactor in the presence of steam and an alkali metal gasification catalyst under suitable temperature and pressure to form a plurality of gaseous products comprising methane and at least one or more of hydrogen, carbon monoxide, carbon dioxide, hydrogen sulfide, ammonia and other higher hydrocarbons, and a petroleum coke char residue comprising an alkali metal gasification catalyst residue;
substantially extracting the alkali metal gasification catalyst residue from the petroleum coke char residue to form the carbon-containing adsorbent material; and
contacting the carbon-containing adsorbent material with an oxidizing atmosphere at a temperature in the range of from about 200° C. to about 1300° C.

11. The process of claim 10, further comprising at least partially separating the plurality of gaseous products to form a gas stream comprising a predominant amount of one of the gaseous products.

12. The process of claim 10, further comprising grinding the petroleum coke char residue to reduce its particle size.

13. The process of claim 10, wherein the reaction of the petroleum coke feedstock is carried out in an atmosphere having less than about 1% O₂ by volume.

14. A carbon-containing adsorbent material made by the process of claim 10.
